(19) United States
(12) Patent Application Publication
(10) Pub. No.: US 2024/0344391 A1
(43) Pub. Date: Oct. 17, 2024

(54) Gate Upright

(71) Applicant: Gary W. Ash, Valley Center, CA (US)

(72) Inventor: Gary W. Ash, Valley Center, CA (US)

(21) Appl. No.: 18/753,543

(22) Filed: Jun. 25, 2024

Related U.S. Application Data
(63) Continuation-in-part of application No. 17/735,517, filed on May 3, 2022.
(63) Continuation-in-part of application No. 18/392,830, filed on Dec. 21, 2023.

(51) Int. Cl. E06B 11/02; F16B 11/00

(52) U.S. Cl. CPC E06B 11/02; F16B 11/006

(57) ABSTRACT

A single extrusion gate upright has a hole for a rail and one or more inner walls which can be coated with glue prior to the insertion of the rail. In a preferred embodiment, there are two inner walls, one of which is only a partial inner wall, which allows the user to coat the outside surface of the inner walls with glue, then insert the rail at an angle, to avoid screeding the glue toward the back of the gate upright, then rotate the rail onto the full inner wall, and slide the rail a short distance to lock it behind the partial inner wall. In another preferred embodiment, there is only one full inner wall, and the rail is inserted at an angle, then rotated against the inner wall. Glue beads at intersections between the rail and gate upright form an interlocking bracket for further support.

### CROSS REFERENCE TO RELATED APPLICATIONS

This application claims priority back to U.S. Utility patents application Ser. No. 17/735,517, filed, May 3, 2022, Ser. No. 18/392,830, filed Dec. 21, 2023, and Ser. No. 18/418,983, filed Jan. 22, 2024, the contents of which are incorporated by reference into this application.

### STATEMENT REGARDING FEDERALLY SPONSORED RESEARCH OR DEVELOPMENT

This invention was not federally sponsored.

### BACKGROUND OF THE INVENTION

Field of the invention: This invention relates to the general field of fences and gates, and more specifically toward a gate kit that allows for the creation of a substantially stronger gate that is more aesthetically pleasing as it avoids the external welding of joints that are commonly used today. Because the gate parts fit together, there is no need to paint each part, then re-paint over the welded areas.

By way of a quick summary of the invention, the fence gate kit comprises two or more uprights that create a slot between an inner wall and an outer wall, and horizontal rails that slide into the slot. The uprights are manufactured as a “single extrusion”, which means that all the parts of the uprights are a single “part”. The entire gate upright may have several different shapes-such as an outer gate upright and an inner wall, but each “part” is molecularly bonded to each other part, so molecularly, it is all the same “part”. Specifically, the molecules on the bottom of the inner walls are molecularly attracted to molecules in the gate upright, making it on continuous molecular chain from the inner wall to the gate upright itself. The hot-melt extrusion technique pushes molten metal through a die, creating the gate upright. Because the die can be shaped to have a slot for an internal wall, or two slots for two internal walls, a gate upright with one or more full or partial inner walls can be created as a single, molecularly contiguous unit. This produces a significantly stronger upright as compared with the prior art that often requires an adaptor, screws, bolts or welds that not only are weaker than a single extrusion, but also mar the powder coat. Connecting the two uprights are a top rail and a bottom rail, and the rails are glued into place within the uprights.

The invention has several basic embodiments. First, a gate upright has only a single full inner wall. The outside surface of this full inner wall can be coated with glue. The rail is inserted into an opening in the gate upright, then rotated such that the side of the rail presses against the glue. This avoids the problem that many gate upright devices have where the rail forces the glue off the inner wall and back into the back of the gate upright-a process known as screeding. In a second embodiment, there is a second partial inner wall. Because one of the inner walls does not extend the entire length of the gate upright, glue can be applied to the rail without the rail “screeding”—that is, having the glue stripped off—as it is inserted into the space between the inner wall and the outer wall. Because the inner walls—whether full or partial—are extruded through a die as a single unit, they are molecularly bonded to the outer portions of the gate upright, thereby increasing the strength of the upright. It should be noted that the inner walls can be full inner walls, partial inner walls, walls on only one side of the gate upright, to some combination thereof. Spot welding can optionally be also used to secure the rails in place. The length and width of the upper and lower frames, and the uprights, can be determined by the user, as well as the spacing of the rails, giving the gate kit a truly universal adaptability.

Problem Solved: Current gates have a huge issue that they cannot be micro-fabricated without welding the outer wall. This means the coating must be removed or the gate must be made before coating, then coated with paint or powder coat. This poses an issue if the materials are purchased pre-coated from the manufacturing or extrusion company. Transporting an assembled gate is obviously considerably more expensive than transporting the parts and assembling the gate onsite. What happens is the gates will not be coated in the same place as post and fence sections (the panel installed between the posts that are installed in the ground). This will result in weathering over time at different rates. It is common to have a lifetime warranty and such an issue can result in warranty claims. One such cure is the manufacture that put the coating on the extrusions can do the gate manufacturing but with several styles, heights and colors this will result in massive inventory that would need to be stored and becomes price prohibited. So, only large manufactures have capital and space to house a large enough painting or powder coating line to make this feasible for in-house coating of all the extrusions so that everything weathers the same. By creating a gate that can be made from a kit that the welding or gluing used would not interfere with the life of the gate coating because the method of attachment is located inside the upright internal walls away from the areas that will cause degrading of the coating from the original manufacture. This allows the extrusion company to just sell extrusions pre coated and the micro manufacture or customer can cut the material and make any gate from these special uprights extrusions that have the inner channel or inner walls.

Applicant's Gate Upright is a square tube containing internal walls, manufactured in a single extrusion, that is, it is a single extrusion made without any additional parts that need to be added to it after initial production. Because molten metal is forced through a die, all the parts of the gate upright are molecularly bonded to each other, obviously increasing the strength of the upright. It functions with one or more full or partial internal walls with a strong bond of glue, and without the need to add any adaptors. This creates an extremely strong upright, which is necessary as gates are the most stressed (and abused) part of a fence assembly. In between having the resulting gate maintain its squared or rectangular shape with 90-degree corners, while having only two or three points of attachment, to children swinging on them, the structural integrity of a gate upright is crucial to its function as a gate. Once a gate is bent or twisted out of square and the far corner touches the ground, it ceases to open and close easily unless the user pulls up on the outside upright-which completely defeats the purpose of a swinging gate. The Robbins invention, for example, is not a singular product and requires multiple parts to attempt to accomplish the same result as does the invention that is described in this patent application. However, Robbins fails in that its method of attaching the rails to the gate upright does not provide the secure connection that is provided in the present invention.

It should be noted that the present invention provides one or two inner walls against which the rail lies. By placing glue on the inside of the gate upright on the outer surface of the inner wall or walls, the present invention allows the glue to hold the rail in a position where any side force will be protected by the two inner walls. The prior art has no such protection utilizing a single-extrusion gate upright, relying instead on a mere “assembly of extrusions and molded adaptors” to hang the rail against the gate upright. The current invention needs no such adaptor as the rail slides directly into the gate upright. This invention also allows a user to place glue on the outer surfaces of the inside wall(s) of the gate upright prior to inserting the rail. This prevents screeding of glue as occurs in inventions where glue is applied to the rail first. In particular, having only a single inner wall, or one full inner wall and a partial inner wall, an assembler need only coat the outer surfaces of the inner wall(s) with glue, slide in the rail, square it, and wait a few minutes for the glue to dry. There is no screeding of the glue as in prior art products.

Thus, there has existed a long-felt need for a gate kit that allows for the sturdy, quick, and inexpensive creation of a wide variety of gate sizes and shapes, without resorting to external welding, adaptors, screws or bolts. The current invention provides just such a solution by having a fence gate kit, comprising two single-extrusion uprights with one or more slots into which one or more rails can be slid, where the upright as at least one internal wall against which the rail can be glued. The uprights are manufactured as a “single extrusion”, which means that all the parts of the uprights are a single “part”. The entire gate upright may have several different shapes-such as an outer gate upright and an inner wall, but each “part” is molecularly bonded to each other part, so molecularly, it is all the same “part”. Specifically, the molecules on the bottom of the inner walls are molecularly attracted to molecules in the gate upright, making it on continuous molecular chain from the inner wall to the gate upright itself. The hot-melt extrusion technique pushes molten metal through a die, creating the gate upright. Because the die can be shaped to have a slot for an internal wall, or two slots for two internal walls, a gate upright with one or more full or partial inner walls can be created as a single, molecularly contiguous unit. This produces a significantly stronger upright as compared with the prior art that often requires an adaptor, screws, bolts or welds that not only are weaker than a single extrusion, but also mar the powder coat. Connecting the two uprights are a top rail and a bottom rail, and the rails are glued into place within the uprights.

In a first embodiment, a gate upright has only a single full inner wall. The outside surface of this full inner wall can be coated with glue. The rail is inserted into an opening in the gate upright, then rotated such that the side of the rail presses against the glue. This avoids the problem that many gate upright devices have where the rail forces the glue off the inner wall and back into the back of the gate upright-a process known as screeding. In a second embodiment, there is a second partial inner wall. Because one of the inner walls does not extend the entire length of the gate upright, glue can be applied to the rail without the rail “screeding”—that is, having the glue stripped off—as it is inserted into the space between the inner wall and the outer wall. The uprights are nestled between a top frame and a bottom frame, and the rails are glued into place at the proper spacing within the uprights. Screws or bolts can optionally be also used to secure the rails in place.

To provide further support, after the rails have been inserted into the gate upright, glue beads are laid down by the straw of a glue gun around the top and bottom of the gate upright to form an interlocking bracket made of glue that further strengthens the gate. To form this bracket of glue, the user of the invention lays a bead of glue across the top of the top rail in a gate, and across the bottom of the bottom rail of the gate. This glue bead is thicker than the gap between the intersection of the rail and the upright inner walls, so that it “hangs over” and prevents the rail from rotating up or down. Ideally, the glue bead is laid down on all four sides of the inner portion of the gate upright, across both inner walls and the front and back of the gate upright. Opposing buildup beads of glue attached to the same inner walls creates a locking system to dramatically increase the rigidness of the gate.

By way of a brief summary, Applicant's Gate Upright is a square tube containing internal walls, manufactured in a single extrusion, that is, it is a single extrusion made without any additional parts that need to be added to it after initial production. Because molten metal is forced through a die, all the parts of the gate upright are molecularly bonded to each other, obviously increasing the strength of the upright. It functions with one or more full or partial internal walls with a strong bond of glue, and without the need to add any adaptors. Having only a single inner wall, or one full inner wall and a partial inner wall, an assembler need only coat the outer surfaces of the inner wall(s) with glue, slide in the rail, square it, and wait a few minutes for the glue to dry. There is no screeding of the glue as in prior art products. Alternatively, a spot weld can be done from both the top and bottom of each gate upright, thereby either securing the rail in place, or in addition to the glue, adding additional strength to the eventual gate. Because the spot welding is done inside the gate upright, the powder coat on the exterior of the gate upright and the rail is not disturbed.

There has thus been outlined, rather broadly, certain embodiments of the invention in order that the detailed description thereof may be better understood, and in order that the present contribution to the art may be better appreciated. There are additional features that will be described hereinafter, and which will form the subject matter of the claims appended hereto. The features listed herein, and other features, aspects and advantages of the present disclosure will become better understood with reference to the following description and appended claims.

### STATEMENT OF THE INVENTION

Accordingly, one aspect of the invention includes a fence gate kit which can be adapted to building a gate fence of a variety of sizes, with rails of a variety of spacing gaps.

Preferably, the fence gate kit provides an upper frame, a lower frame, two uprights for each side of the gate, and a number of rails.

Preferably, a purchaser of the gate fence kit can have the frames and uprights pre-cut to his/her preference, such that the gate is the exact size desired.

Preferably the user can slide in an appropriate number of rails to provide a gap spacing similar to the rest of the fence.

Ideally, the user can secure the rails through glue, with the option of also adding a screw to provide quick and additional security.

Another aspect of the invention is the ability to attach frames and rails to uprights without destroying the finish. The way gates are made today, there is excessive external welding which is very difficult to paint over and have the new paint stick to the weld and resist rust.

A further advantage of this invention is that in moving the weld or the method of attachment from the outside wall to inside the rail to protect pre coated extrusions (and not require repainting of any external welded areas), the invention provides a kit that allows gates to be assembled in a small fabrication facility that lacks the ability to coat the extrusions with the same quality of finish coating paint or powder coating.

Another advantage of this gate kit is that in moving the method of attachment to the inside of the upright rather than relying on welds on the outside, the resulting product has stronger joints and eliminates flex in the face of the upright, thereby allowing thinner profiles to be used resulting in less supportive bracing on the gate and an overall lighter and cost-effective gate.

The versatility of the gate kit also allows for an upright member to have more than one inner walls to create new locations for attachment of rails, (horizontal extrusions), such that a user of the invention need only decide on how many rails there are and the location of the rails, and he/can be create a custom gate with no external welds.

Another aspect of the invention is that the channel created in the uprights by the inner box beams “locks” the horizontal member or frame member such that it can rotate only vertically and not horizontally, thereby enhancing the rigidness of the gate and making it significantly stronger that the prior art gates.

A further aspect of the invention is to allow design micro fabrication facilities to fabricate custom gates without the fear of creating gates that will weather at a dissimilar rate to the rest of the fence, as is the case where there is a gate with external welds. This gate kit allows a micro fabricator to create a gate that will not degrade the extrusion coating when manufacturing the gate.

A further aspect of the invention is that both embodiments of the invention avoid the screeding of glue, which results is a significantly stronger bond between the side of the rail and the inner wall. In the first embodiment, the gate upright has only a single full inner wall. The outside surface of this full inner wall can be coated with glue. The rail is inserted into an opening in the gate upright, then rotated such that the side of the rail presses against the glue. This avoids the problem that many gate upright devices have where the rail forces the glue off the inner wall and back into the back of the gate upright-a process known as screeding. In a second embodiment, there is a second partial inner wall. because one of the inner walls does not extend the entire length of the gate upright, glue can be applied to the rail without the rail “screeding”—that is, having the glue stripped off—as it is inserted into the space between the inner wall and the outer wall.

Another aspect of the invention is to provide a square tube containing internal walls, manufactured in a single extrusion, that is, it is a single extrusion made without any additional parts that need to be added to it after initial production. Because molten metal is forced through a die, all the parts of the gate upright are molecularly bonded to each other, obviously increasing the strength of the upright. It functions with one or more full or partial internal walls with a strong bond of glue, and without the need to add any adaptors. Having only a single inner wall, or one full inner wall and a partial inner wall, an assembler need only coat the outer surfaces of the inner wall(s) with glue, slide in the rail, square it, and wait a few minutes for the glue to dry. There is not screeding of the glue as in prior art products. Alternatively, a spot weld can be done from both the top and bottom of each gate upright, thereby either securing the rail in place, or in addition to the glue, adding additional strength to the eventual gate. Because the spot welding is done inside the gate upright, the powder coat on the exterior of the gate upright and the rail is not disturbed.

A final aspect of the invention is the use of a glue bead around the top and bottom of the gate upright to form an interlocking bracket made of glue that further strengthens the gate. To form this bracket of glue, a glue gun straw is used to lay a bead of glue across the top of the top rail in a gate, and across the bottom of the bottom rail of the gate. This glue bead is thicker than the gap between the intersection of the rail and the upright inner walls, so that it “hangs over” and prevents the rail from rotating up or down. Ideally, the glue bead is laid down on all four sides of the inner portion of the gate upright, across both inner walls and the front and back of the gate upright. Opposing buildup beads of glue attached to the same inner walls creates a locking system to dramatically increase the rigidness of the gate.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

The accompanying drawings, which are incorporated in and form a part of this specification, illustrate embodiments of the disclosure and together with the description, serve to explain the principles of this invention. One preferred form of the invention will now be described with reference to the accompanying drawings.

FIG. 1 is a series of views showing how a gate upright typical of this invention is organized. Of particular interest is the fact that one of the inner walls does not extend the entire length of the gate upright.

FIG. 2 is a series of views showing how a gate upright with only one full inner wall is organized.

FIG. 3 is a series of views showing how a gate upright with two full inner walls that extend the entire length of the gate upright is organized.

FIG. 4 is two views of two different aspects of the invention, where one aspect has two inner walls that extend the entire length of the gate upright, and the second has one inner wall that does not extend the entire length of the gate upright.

FIG. 5 is a series of views of the embodiment of the invention with two walls that extend the entire length of the gate upright, showing how the glue is screeded away from the sides of the rail and pushed to the end of the receptacle in the gate upright.

FIG. 6 is a series of views of the “partial inner wall” embodiment of the invention with one inner wall that does not extend the entire length of the gate upright, showing how the glue can be applied to the sides of the rail, then the rail can be inserted at an angle, when the rail is straightened out and fully inserted into the receptacle, effectively preventing the screeding seen in FIG. 5.

FIG. 7 is a series of views of how a rail can be inserted into a gate upright with only one full inner wall to avoid the screeding seen in FIG. 5.

FIG. 8 is a series of views showing how a rail that is inserted between two full inner walls causes screeding of glue.

FIG. 9 is perspective and a close-up perspective view of a gate upright with two full inner walls where the glue has been screeded away.

FIG. 10 is series of views of a glue gun being used to backfill the space between a rail and a full inner wall.

FIG. 11 is a perspective view and a close-up view of a glue gun backfilling the space between a rail and a full inner wall.

FIG. 12 is a perspective view and a close-up view of a glue gun backfilling the space between a rail and a full inner wall.

FIG. 13 is a top view of a glue gun building up a glue bead on top of a rail that has been inserted into a gate upright.

FIG. 14 are a series of side views of glue beads being used to provide upper and lower bracket support to a rail.

FIG. 15 is a front view of a gate panel where glue beads across the upper surface of the top rail, and the lower surface of the bottom rail to form an interlocking bracket of glue, which only adds to the structural rigidity of the squareness of the corners of the gate.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

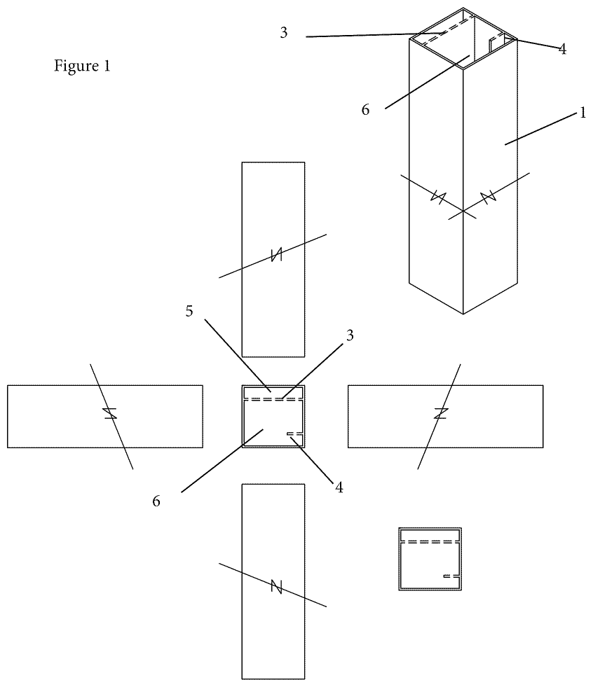

FIG. 1 is a series of views showing how a gate upright 1 typical of this invention is organized. Of particular interest is the fact that one of the inner walls, a partial inner wall 4 does not extend the entire length of the gate upright while the other inner wall, a full inner wall 3. An inner box beam 5 is formed by the backside of the full inner wall and the inner wall of the gate upright. On the other side of the gate upright, however, the partial inner wall 4 does not form an enclosed box beam. This fact will become more important in later figures, as we illustrate the problems of keeping the glue between the sides of the rail and the inner walls.

It should be noted that the invention provides a square tube containing internal walls, manufactured in a single extrusion, that is, it is a single extrusion made without any additional parts that need to be added to it after initial production. Because molten metal is forced through a die, all the parts of the gate upright are molecularly bonded to each other, obviously increasing the strength of the upright. It functions with one or more full or partial internal walls with a strong bond of glue, and without the need to add any adaptors. Having only a single inner wall, or one full inner wall and a partial inner wall, an assembler need only coat the outer surfaces of the inner wall(s) with glue, slide in the rail, square it, and wait a few minutes for the glue to dry. There is no screeding of the glue as in prior art products. Alternatively, a spot weld can be done from both the top and bottom of each gate upright, thereby either securing the rail in place, or in addition to the glue, adding additional strength to the eventual gate. Because the spot welding is done inside the gate upright, the powder coat on the exterior of the gate upright and the rail is not disturbed.

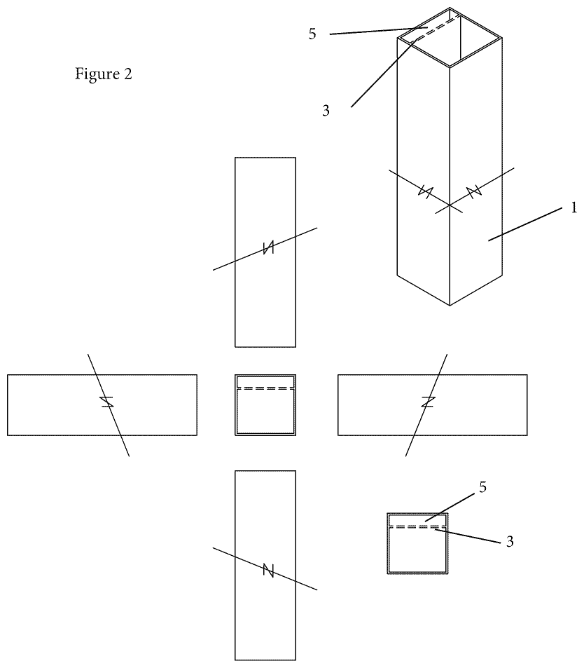

FIG. 2 is a series of views showing how a gate upright with only one full inner wall 3 is organized.

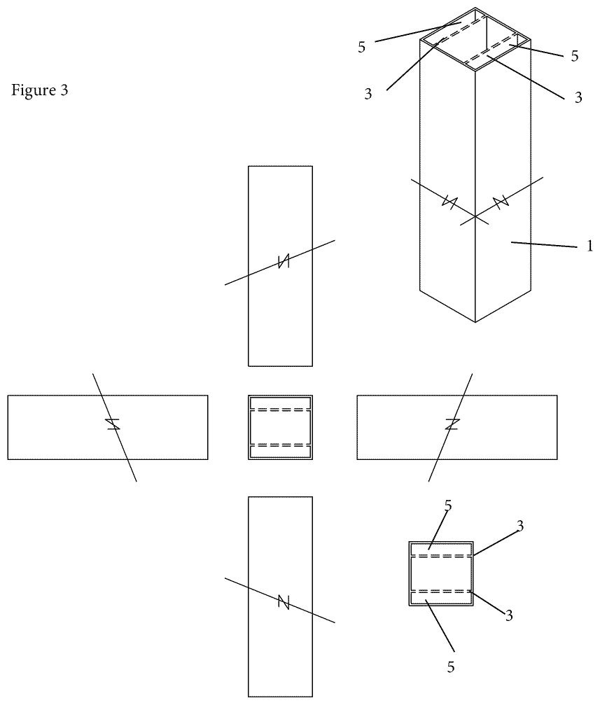

FIG. 3 is a series of views showing how a gate upright with two full inner walls 3 that extend the entire length of the gate upright is organized.

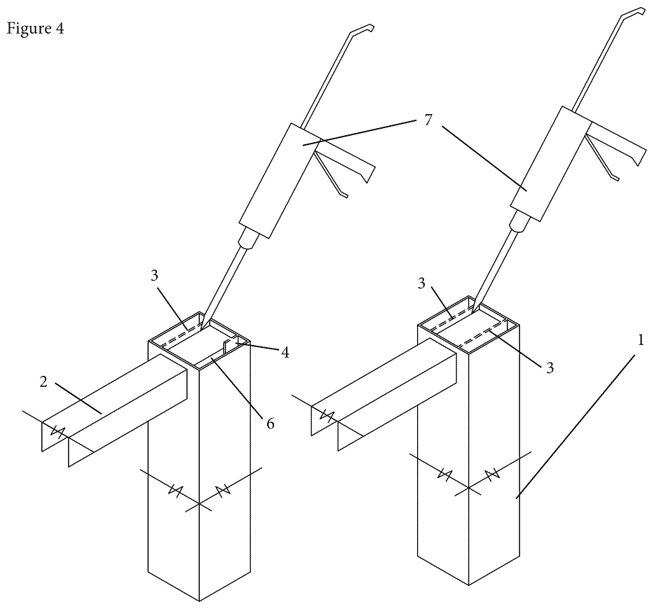

FIG. 4 is two views of two different aspects of the invention, where one aspect has two full inner walls 3 that extend the entire length of the gate upright, and the second has one partial inner wall 4 that does not extend the entire length of the gate upright. In this figure, a glue gun 7 is applying glue to the top of the rail 2, but the differences in how well glue already placed on the inner walls is retained will be vastly different, as will be seen in later figures. Because the gate upright is manufactured in a single extrusion, that is, it is a single extrusion made without any additional parts that need to be added to it after initial production. Because molten metal is forced through a die, all the parts of the gate upright are molecularly bonded to each other, obviously increasing the strength of the upright.

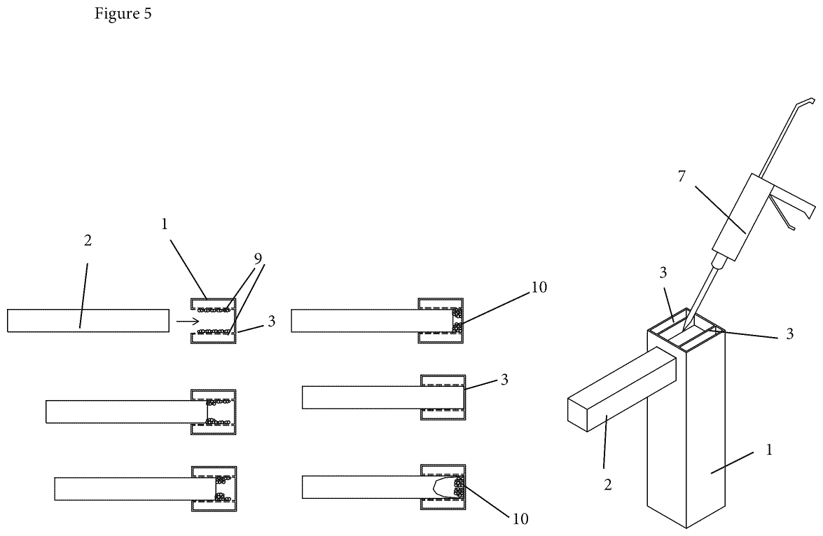

FIG. 5 is a series of views of the embodiment of the invention with two full inner walls 3 that extend the entire length of the gate upright, showing how the glue 9 is screeded away from the sides of the rail 2 and pushed to the end of the receptacle in the gate upright. Prior to being inserted into the gate upright 1, the inner surfaces of the inner walls are coated with glue. It is optimum to have that glue remain between the rail and the inner wall. However, in this figure, with two full inner walls 3, the ends of the rail push or screed the glue into the back of the gate upright, thereby minimizing its effectiveness is securing the sides of the rail to the inner walls.

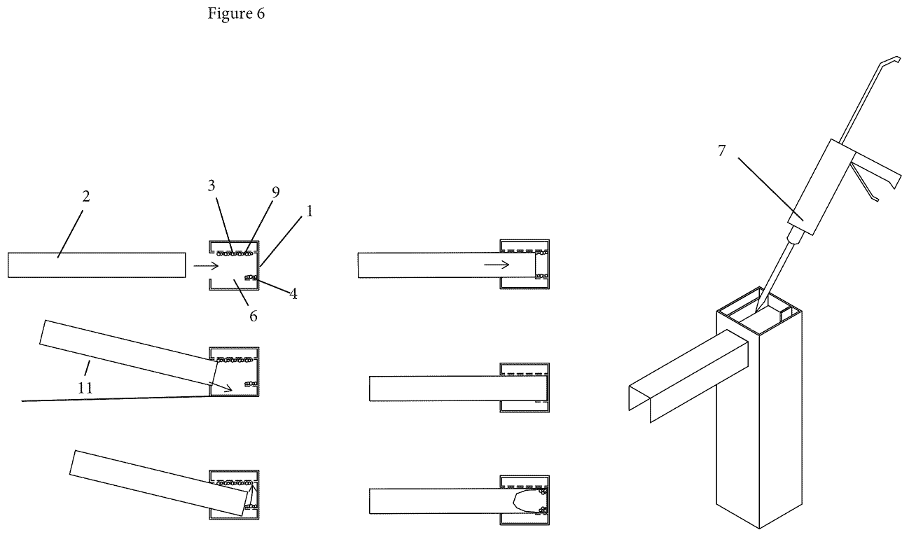

FIG. 6 is a series of views of the “partial inner wall” embodiment of the invention with one partial inner wall 4 that does not extend the entire length of the gate upright 1, showing how the glue can be applied to the outer sides inner walls, then the rail 2 can be inserted at an angle 11, and when the rail is straightened out and fully inserted into the receptacle, it effectively prevents the screeding seen in FIG. 6. Notice how in this figure the glue 9 remains between the side of the rail 2 and both of the inner walls. This creates a substantially better bond than can be seen in FIG. 5, where the only glue securing the sides of the rail to the inner walls is a thin film of glue left over after the main body of glue has been screeded to the back of the gate upright.

This is a significant improvement over the prior art. Previous gate uprights were often multi-piece contraptions that required additional assembly and often used welds, which destroyed the powder coating. Other prior art relied upon the glue along to withstand lateral pressure, while this embodiment provides inner walls the resist later pressure.

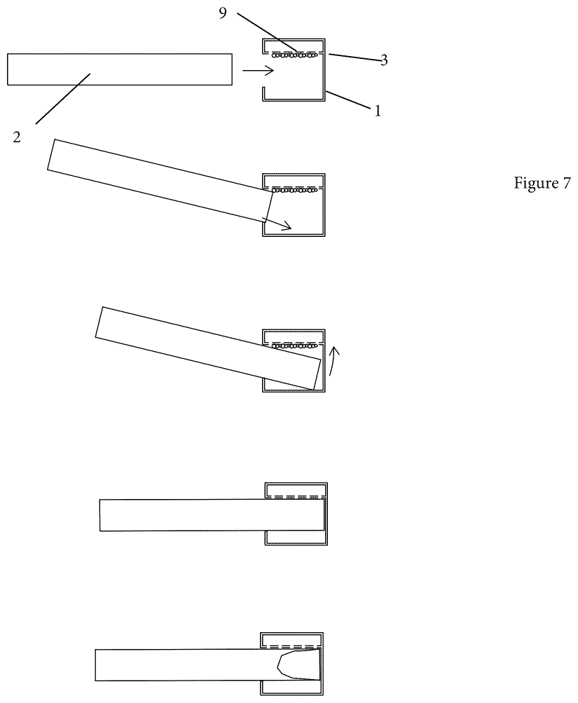

FIG. 7 is a series of views of how a rail can be inserted into a gate upright with only one full inner wall to avoid the screeding seen in FIG. 5. In this embodiment of the invention, the gate upright 1 has only a single full inner wall 3. Glue has been placed on the outer surface of the inner wall, and a rail is inserted at an angle to avoid screeding the glue to the end of the gate upright. After the rail 2 has been inserted fully, it is rotated back against the outer surface of a single full inner wall 3, such that the glue 9 remains between the side of the rail and the inner wall.

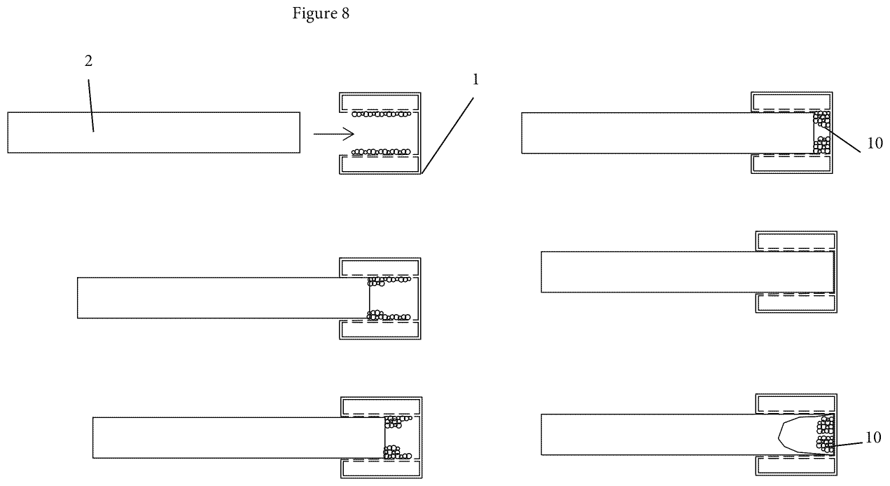

FIG. 8 is a series of views showing how a rail that is inserted between two full inner walls causes screeding of glue. As the rail 2 is pushed into the gate upright, the glue that has been applied earlier is pushed to the back of the gate upright through a process known as screeding. The screeded glue 10 provides limited support because it has been pushed back from the sides of the rail.

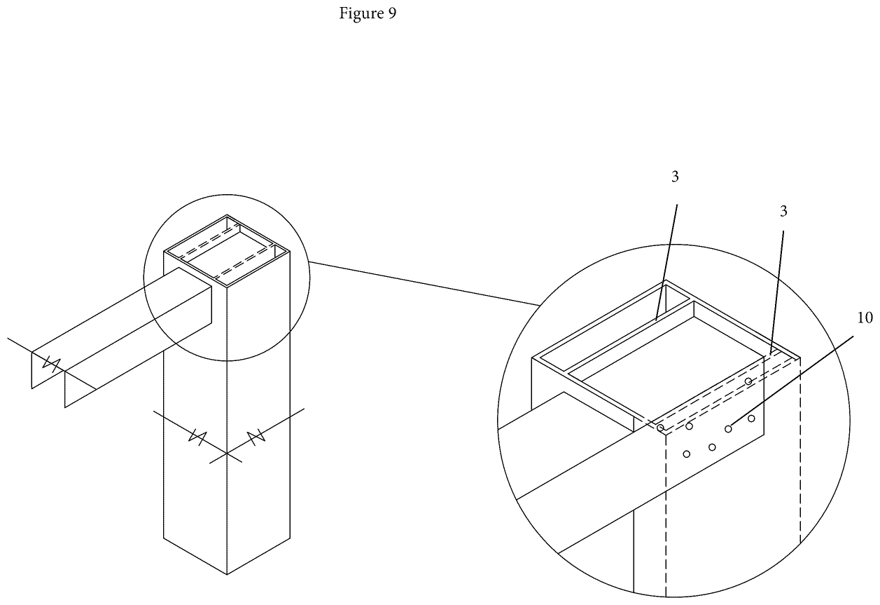

FIG. 9 is perspective and a close-up perspective view of a gate upright with two full inner walls 3 where the glue has been screeded away. The screeded glue 10 is shown by tiny dots, which are very spaced out, indicating that most of the glue has been pushed back.

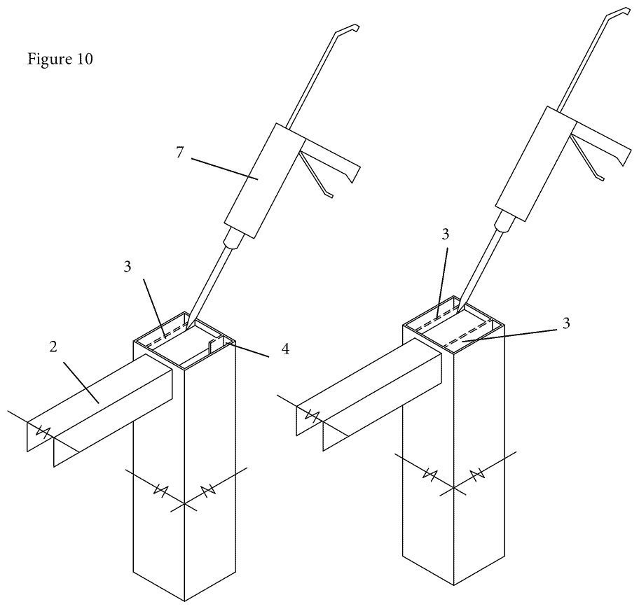

FIG. 10 is series of views of a glue gun 7 being used to backfill the space between a rail 2 and a full inner wall 3. Here, the glue gun is being used to backfill the glue between the sides of the rail and outer surface of the full inner wall.

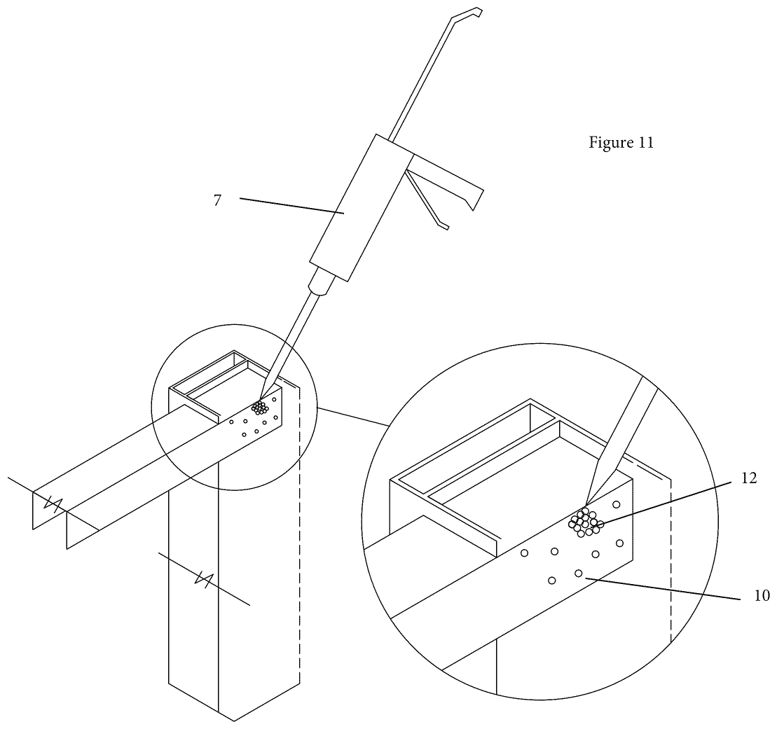

FIG. 11 is a perspective view and a close-up view of a glue gun 7 backfilling the space between a rail and a full inner wall. The backfilled glue 12 slowly fills in the gaps between the small particles of screeded glue 10 that have been left after the rail has been inserted and pushed most of the glue back to the back of the gate upright.

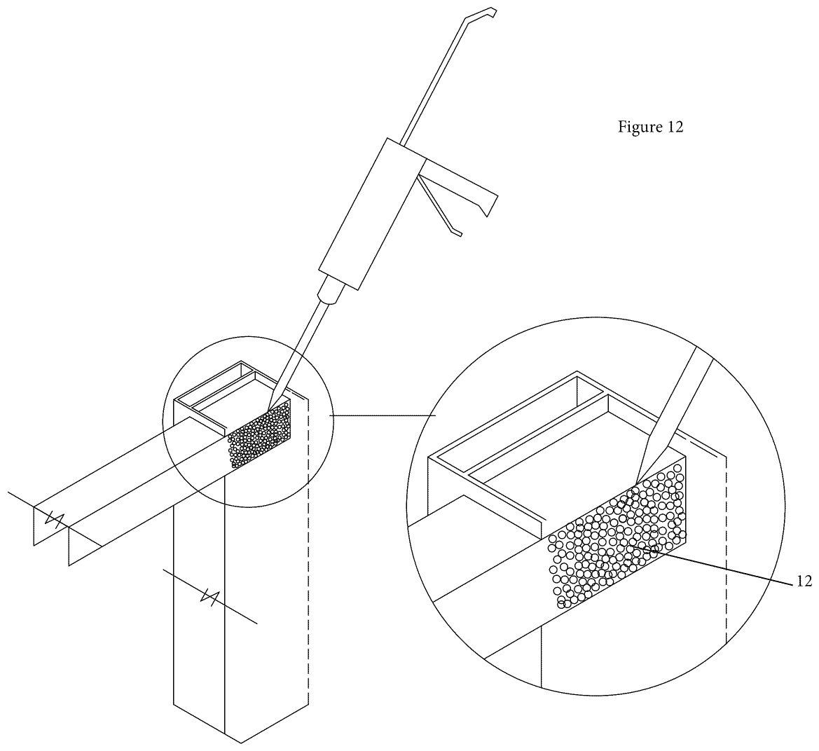

FIG. 12 is a perspective view and a close-up view of a glue gun backfilling the space between a rail and a full inner wall. Here, the backfilling is complete, and there is a nice layer of backfilled glue 12 between the side of the rail and the outer surface of the inner wall.

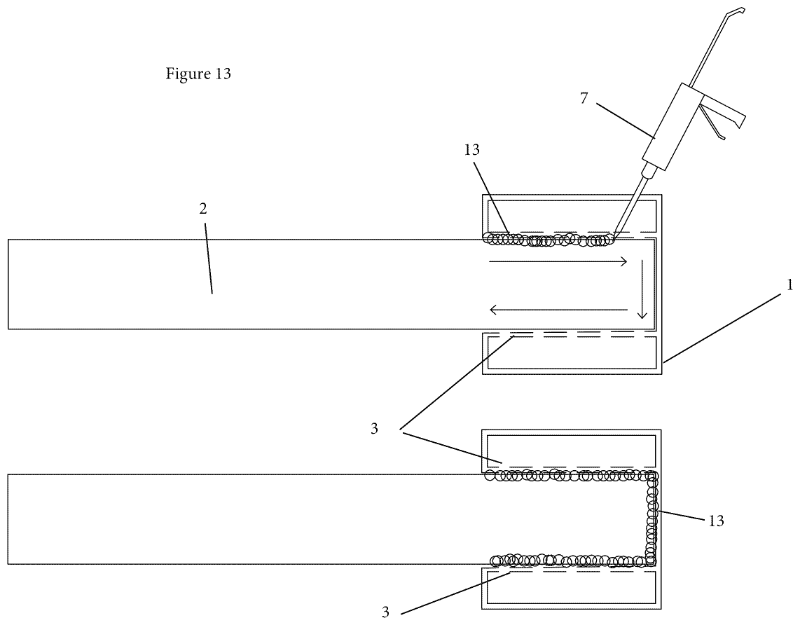

FIG. 13 is a top view of a glue gun 7 building up a glue bead 13 on top of a rail 2 that has been inserted into a gate upright 1. As a final touch of security, a glue bead 13 is laid down on the intersection of the rail edge and the outer surface of the inner wall. The glue bead 13 extends laterally across at least a part of the rail, offering additional support.

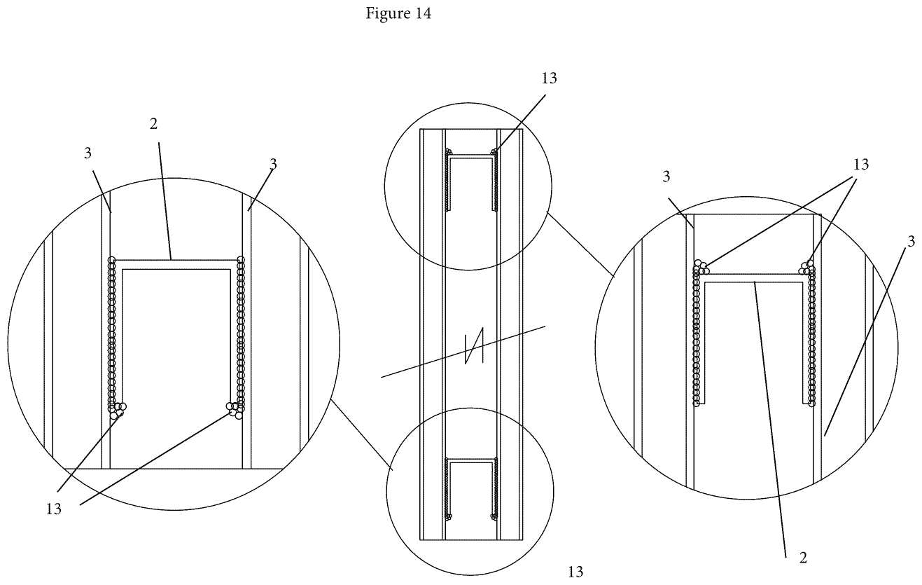

FIG. 14 are a series of side views of glue beads being used to provide upper and lower bracket support to a rail 2. In this figure, a glue bead 13 has been laid over the lower surface of the bottom rail, and over the upper surface of the upper rail.

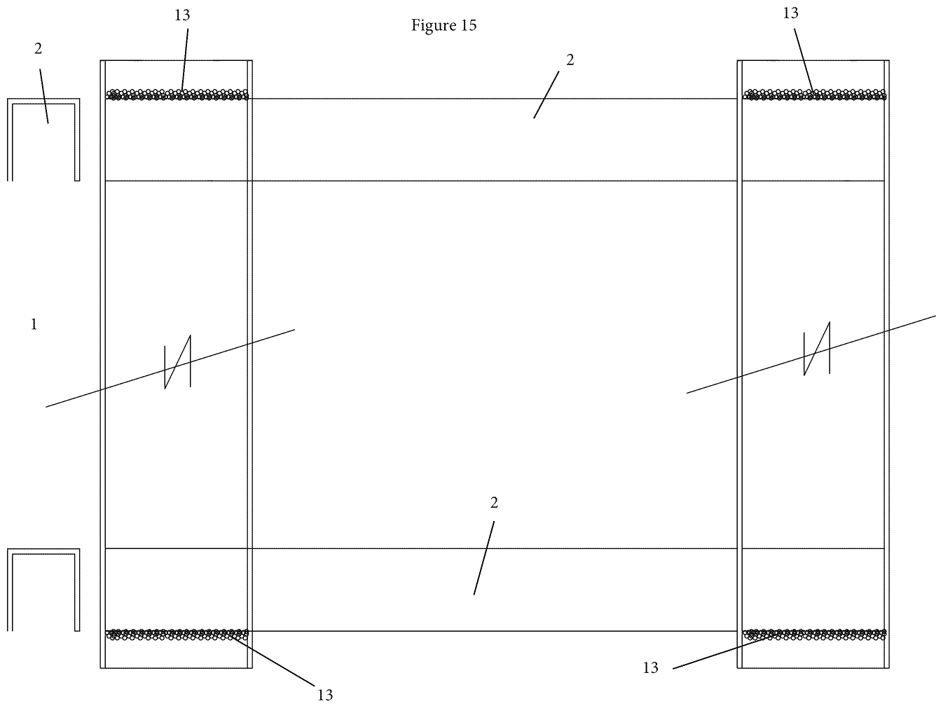

FIG. 15 is a front view of a gate panel where glue beads 13 across the upper surface of the top rail, and the lower surface of the bottom rail to form an interlocking bracket of glue, which only adds to the structural rigidity of the squareness of the corners of the gate.

In one embodiment of the invention, a single extrusion gate upright has several holes into which rails can be inserted. Inside of the gate upright and molecularly bonded to the gate upright through the single extrusion process is a single inner wall. The inner wall can be full or partial. The end side of the rail and or the inner side of the inner wall is coated with glue. The rail is inserted in a sideways manner so as not to screed the glue. Once the rail is inserted, it is rotated to “smack” the inner wall, as opposed to the prior art where the coated end had to “slide” in between two full inner walls, thereby losing most of the glue to screeding.

In another embodiment, there are two inner walls, of what at least one is a partial inner wall. This allows the rail still to be inserted at an angle over the partial inner wall, then “smacked” into the other inner wall.

For all the embodiments of this invention, the uprights are manufactured as a “single extrusion”, which means that all the parts of the uprights are a single “part”. The entire gate upright may have several different shapes-such as an outer gate upright and an inner wall, but each “part” is molecularly bonded to each other part, so molecularly, it is all the same “part”. Specifically, the molecules on the bottom of the inner walls are molecularly attracted to molecules in the gate upright, making it on continuous molecular chain from the inner wall to the gate upright itself. The hot-melt extrusion technique pushes molten metal through a die, creating the gate upright. Because the die can be shaped to have a slot for an internal wall, or two slots for two internal walls, a gate upright with one or more full or partial inner walls can be created as a single, molecularly contiguous unit. This produces a significantly stronger upright as compared with the prior art that often requires an adaptor, screws, bolts or welds that not only are weaker than a single extrusion, but also mar the powder coat. Connecting the two uprights are a top rail and a bottom rail, and the rails are glued into place within the uprights.

It should be noted that a preferred embodiment calls for the glue to be applied to the outer side of the inner wall(s) of the gate upright, but it is also contemplated that the glue can be applied directly to the rail prior to its insertion.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention. Indeed, it will be apparent to one of skill in the art how alternative functional configurations can be utilized to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Although the disclosure herein is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments, whether or not such embodiments are described and whether or not such features are presented as being a part of a described embodiment. Thus, the breadth and scope of the present invention should not be limited by any of the above-described exemplary embodiments.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

Reference Numbers used.
1. Gate upright
2. rail
3. full inner wall
4. partial inner wall
5. inner box beam
6. Gap.
7. Glue Gun
8. Impact pressure
9. Glue
10. Screeded glue
11. Angle
12. Backfilled glue
13. Glue bead

That which is claimed:

1. A fence gate kit, consisting of two gate uprights and at least two rails, wherein each of the two gate uprights is a single extrusion gate upright, wherein the single extrusion gate upright has at least one opening into which a rail end of one of the at least two rails is inserted, wherein the single extrusion gate upright has one full inner wall, wherein the full inner wall extends from a first upright side to a second upright side, and extends from an upright top to an upright bottom, wherein the one full inner wall creates an inner box beam, wherein the one full inner wall is molecularly bonded to an external portion of the upright.

2. The fence gate kit of claim 1, wherein a quantity of glue is applied to an outer surface of the one full inner wall, and wherein the rail is inserted into the opening at an angle, and then, once the rail is fully inserted, rotated such a rail side adheres itself to the outer surface of the one full inner wall.

3. The fence gate kit of claim 2, wherein the screeding of glue is minimized.

4. The fence gate kit of claim 2, wherein one or more lines of glue are applied to a top intersection between a rail top and the one full inner wall, and a bottom intersection between a rail bottom and the one full inner wall.

5. The fence gate kit of claim 1, wherein the gate upright additionally comprises a partial inner wall, wherein the partial inner wall has a back section, wherein the back section intersects a back of the single extrusion gate upright from the upright top to the upright bottom, and a front section, wherein the front section intersection a front of the gate upright only partially, leaving a gap, wherein the rail is inserted into the opening at an angle, wherein the rail is inserted into the gap, wherein the rail is then rotated such that a rail side adheres itself to the outer surface of the one full inner wall wherein the rail is then pushed until a rail end touches the back of the gate upright.

6. The fence gate kit of claim 5, wherein the screeding of glue is minimized, wherein one or more lines of glue are applied to a top intersection between a rail top and the one full inner wall, and a bottom intersection between a rail bottom and the one full inner wall, creating an interlocking bracket of glue.

7. The fence gate kit of claim 6, wherein the one more rail enters the gate upright at one of the at least two second upright openings, wherein there is an upper rail and a lower rail, wherein the interlocking bracket of glue stabilizes a fence gate.

8. The fence gate kit of claim 7, wherein four upper lines of glue beads are laid down at the intersection of two full inner walls, a gate upright back and a gate upright front, with a top surface of a top rail, and four lower lines of glue beads are laid down at the intersection of the two full inner walls, the gate upright back and the gate upright front, a bottom surface of a bottom rail, creating an interlocking bracket of glue, wherein each of the four upper lines of glue beads and each of the four lower lines of glue beads is thicker than the gap between the intersection of the rail and the gate upright.

9. A fence gate kit, comprising: an upright and a rail, wherein the upright is a single extrusion gate upright, wherein the upright has an opening into which the rail is inserted, wherein the upright has an inner wall, wherein the inner wall extends from a first upright side, and extends from an upright top to an upright bottom, wherein the inner wall creates an inner box space, wherein the inner wall is molecularly bonded to an external portion of the upright.

10. The fence gate kit of claim 9, wherein the inner wall is a full inner wall.

11. The fence gate kit of claim 9, wherein the inner wall is a partial inner wall.

12. The fence gate kit of claim 9, wherein a quantity of glue is applied to an outer surface of the one full inner wall, and wherein the rail is inserted into the opening at an angle, and then, once the rail is fully inserted, rotated such a rail side adheres itself to the outer surface of the one full inner wall.

13. The fence gate kit of claim 12, wherein the screeding of glue is minimized, wherein one or more lines of glue are applied to a top intersection between a rail top and the one full inner wall, and a bottom intersection between a rail bottom and the one full inner wall.

14. The fence gate kit of claim 13, wherein the gate upright additionally comprises a partial inner wall, wherein the partial inner wall is molecularly bonded to an external portion of the upright, wherein the partial inner wall has a back section, wherein the back section intersects a back of the gate upright from the upright top to the upright bottom, and a front section, wherein the front section intersection a front of the gate upright only partially, leaving a gap, wherein the rail is inserted into the opening at an angle, wherein the rail is inserted into the gap, wherein the rail is then rotated such that a rail side adheres itself to the outer surface of the one full inner wall wherein the rail is then pushed until a rail end touches the back of the gate upright.

15. The fence gate kit of claim 9, wherein the gate upright comprises more than one opening to accommodate multiple rails, and wherein the gate upright comprises more than one rail, and, wherein each rail is inserted into an opening the create a gate frame, and wherein each rail has a plurality of rail openings through which a plurality of pickets are inserted.

16. The fence gate kit of claim 15, additionally comprising a second upright, wherein the second upright is a single extrusion gate upright, wherein the second upright has at least two second upright openings, and one more rail, wherein the one more rail enters the gate upright at one of the at least two second upright openings, wherein there is an upper rail and a lower rail, wherein the interlocking bracket of glue stabilizes a fence gate.

17. The fence gate kit of claim 16, wherein four upper lines of glue beads are laid down at the intersection of two full inner walls, a gate upright back and a gate upright front, with a top surface of a top rail, and four lower lines of glue beads are laid down at the intersection of the two full inner walls, the gate upright back and the gate upright front, a bottom surface of a bottom rail, creating an interlocking bracket of glue, wherein each of the four upper lines of glue beads and each of the four lower lines of glue beads is thicker than the gap between the intersection of the rail and the gate upright.

18. A gate upright, wherein the upright is a single extrusion gate upright, wherein the gate upright comprises an opening into which a rail can be inserted, wherein the gate upright has one full inner wall, wherein the full inner extends from a first upright side to a second upright side, and extends from an upright top to an upright bottom, wherein the one full inner wall creates an inner box beam, wherein the one full inner wall is molecularly bonded to the external portion of the upright.

19. The gate upright of claim 18, wherein a quantity of glue is applied to an outer surface of the one full inner wall, and wherein the rail can be inserted into the opening at an angle, and then, once the rail is fully inserted, rotated such a rail side adheres itself to the outer surface of the one full inner wall.

20. The fence gate kit of claim 19, wherein the gate upright additionally comprises a partial inner wall, wherein the partial inner wall is molecularly bonded to an external portion of the upright, wherein the partial inner wall has a back section, wherein the back section intersects a back of the gate upright from the upright top to the upright bottom, and a front section, wherein the front section intersection a front of the gate upright only partially, leaving a gap, wherein the rail is inserted into the opening at an angle, wherein the rail is inserted into the gap, wherein the rail is then rotated such that a rail side adheres itself to the outer surface of the one full inner wall wherein the rail is then pushed until a rail end touches the back of the gate upright.

21. The fence gate kit of claim 20, wherein the screeding of glue is minimized, wherein one or more lines of glue are applied to a top intersection between a rail top and the one full inner wall, and a bottom intersection between a rail bottom and the one full inner wall, creating an interlocking bracket of glue, wherein the gate upright comprises more than one opening to accommodate multiple rails, and wherein the gate upright comprises more than one rail, and, wherein each rail is inserted into an opening the create a gate frame, and wherein each rail has a plurality of rail openings through which a plurality of pickets are inserted.

22. The fence gate kit of claim 21, wherein four upper lines of glue beads are laid down at the intersection of two inner walls, a gate upright back and a gate upright front, with a top surface of a top rail, and four lower lines of glue beads are laid down at the intersection of the two inner walls, the gate upright back and the gate upright front, a bottom surface of a bottom rail, creating an interlocking bracket of glue, wherein each of the four upper lines of glue beads and each of the four lower lines of glue beads is thicker than the gap between the intersection of the rail and the gate upright.

23. A fence gate kit, comprising: two uprights and two rails, wherein each of the uprights has two openings into which the rails are inserted, wherein the upright has at least one inner wall, wherein at least one inner wall is molecularly bonded to an external portion of the upright, wherein at least one inner wall extends from a first upright side, and extends from an upright top to an upright bottom, wherein the at least one inner wall creates an inner box beam space, wherein a quantity of glue is applied to an outer surface of the at least one inner wall, and wherein the rails are inserted into the two openings, and then, once the rail is fully inserted, wherein a quantity of backfilled glue is inserted into two spaces between a rail side and an outer side of a full inner wall.

24. The fence gate kit of claim 23, wherein there is one inner wall and the one inner wall is a full inner wall.

25. The fence gate kit of claim 23, wherein there is one inner wall and the one inner wall is a partial inner wall.

26. The fence gate kit of claim 23, wherein there are two inner walls and both of the two inner walls are full inner walls.

27. The fence gate kit of claim 23, wherein there two inner walls and a first inner wall of the two inner walls is a full inner wall and a second inner wall of the two inner walls is a partial inner wall.

28. The fence gate kit of claim 23, two inner walls and both of the two inner walls are partial inner walls.

29. The fence gate kit of claim 22, wherein one or more lines of glue are applied to a top intersection between a rail top and the one full inner wall, and a bottom intersection between a rail bottom and the one full inner wall, creating an interlocking bracket of glue.

30. The fence gate kit of claim 29, additionally comprising at least one middle rail, wherein the at least one middle rail is inserted into at least one middle opening on each of the gate uprights.

31. The fence gate kit of claim 30, wherein four upper lines of glue beads are laid down at the intersection of two full inner walls, a gate upright back and a gate upright front, with a top surface of a top rail, and four lower lines of glue beads are laid down at the intersection of the two full inner walls, the gate upright back and the gate upright front, a bottom surface of a bottom rail, creating an interlocking bracket of glue, wherein each of the four upper lines of glue beads and each of the four lower lines of glue beads is thicker than the gap between the intersection of the rail and the gate upright.
